(19) United States
(12) Patent Application Publication
(10) Pub. No.: US 2007/0014216 A1
(43) Pub. Date: Jan. 18, 2007

(54) METHOD OF DETERMINING RECORDING POWER AND OPTICAL DISC DRIVE APPARATUS

(76) Inventor: Shigeru Shimakawa, Yokohama-City (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/278,062

(22) Filed: Mar. 30, 2006

(30) Foreign Application Priority Data
Jul. 14, 2005 (JP) 2005-205883

(51) Int. Cl. G11B 7/00

(52) U.S. Cl. 369/47.5; 369/116

(57) ABSTRACT

A method of determining a recording power, includes carrying out DC erase with respect to a power calibration area of a phase-change optical disc, recording data to with respect to the power calibration area carrying out the DC erase while changing recording power, reading the recorded data to obtain a read signal, and determining an optimum recording power based on the read signal.

### CROSS-REFERENCE TO RELATED APPLICATIONS

This application is based upon and claims the benefit of priority from prior Japanese Patent Application No. 2005-205883, filed Jul. 14, 2005, the entire contents of which are incorporated herein by reference.

### BACKGROUND OF THE INVENTION

1. Field of the Invention

The present invention relates to a method of determining recording power when recording data to a phase-change optical disc, and to an optical disc drive apparatus.

2. Description of the Related Art

An optical disc drive apparatus is able to record data to an optical disc. The optical disc drive apparatus needs to achieve recording power optimization calling OPC (Optimum Power Control) to determine an optimum recording power before recording data to the optical disc using laser beam. In order to achieve the foregoing OPC, test recording is made with respect to a recording test area of the optical disc calling PCA (Power Calibration Area) while changing the recording power. Then, optimum recording power is determined from a read signal of the test recording data.

In a rewritable phase-change optical disc, modulation factor m is determined from a read signal of the test recording data every recording power. Then, a predetermined target value, that is, target power is determined from a γ value obtained from the modulation factor m. The target power is multiplied by a coefficient ρ to determine a recording power.

However, phase-change optical discs having a non-uniform phase-change film are circulated on the market. In particular, if crystal grains are non-uniform in the PCA, the following problem arises when carrying out the foregoing OPC. Resulting from non-uniformity of phase-change film, recording is made using large recording power; nevertheless, the same modulation as a RF waveform when recording is made using small recording power is given. For this reason, uniformity is not obtained when the recording power is calculated using β and γ values.

The technique of solving the foregoing problem has been disclosed (e.g., JPN. PAT. APPLN. KOKAI Publication No. 2003-67925, paragraph numbers [0027] to [0034]). According to the technique disclosed in the foregoing Publication, a target power is calculated based on the inclination of a change to recording power of modulation factor m. The calculated target power is multiplied by a coefficient z to determine recording power.

In the foregoing technique, the target power is multiplied by a coefficient z to determine recording power. However, the coefficient z is not used for determining optimum recording power in general. Therefore, the coefficient z is not determined. In other words, if the OPC is carried out with respect to a phase-change optical disc having a lead-in area previously recording no coefficient z, the foregoing technique dose not determine the optimum recording power.

### BRIEF SUMMARY OF THE INVENTION

According to one aspect of the present invention, there is provided a method of determining a recording power, comprising: a step of carrying out DC erase to a power calibration area of a phase-change optical disc; a step of recording data to the power calibration area after carrying out the DC erase while changing recording power; a step of reading the recorded data to obtain a read signal; and a step of determining an optimum recording power based on the read signal.

### BRIEF DESCRIPTION OF THE SEVERAL VIEWS OF THE DRAWING

FIG. 1 is a block diagram schematically showing the configuration of an optical disc drive apparatus according to one embodiment of the present invention;

FIG. 2 is a flowchart to explain the OPC procedure according to one embodiment of the present invention;

FIG. 3 is a view to explain modulation factor m; and

FIGS. 4A and 4B are photographs showing the waveform of a RF signal obtained from a phase-change optical disc.

### DETAILED DESCRIPTION OF THE INVENTION

One embodiment of the present invention will be described below with reference to the accompanying drawings.

In this embodiment, OPC for recoding data to a record-rewritable phase-change optical disc will be explained. The phase-change optical disc records and erases information using a reversible phase change between crystal and amorphous layers in a recording layer. Moreover, a read signal is read using the optical characteristic difference (usually, reflectance difference) between crystal and amorphous layers. Recording is made in the following manner. Namely, a laser beam having write power Po is radiated so that the recoding layer becomes temperature of a melting point or more, and thereby, the crystal layer is changed into an amorphous layer. Usually, erase is made is made in the following manner. Namely, a laser beam having erase power Pe (<write power Po) is radiated so that the recoding layer becomes temperature of a melting point or more.

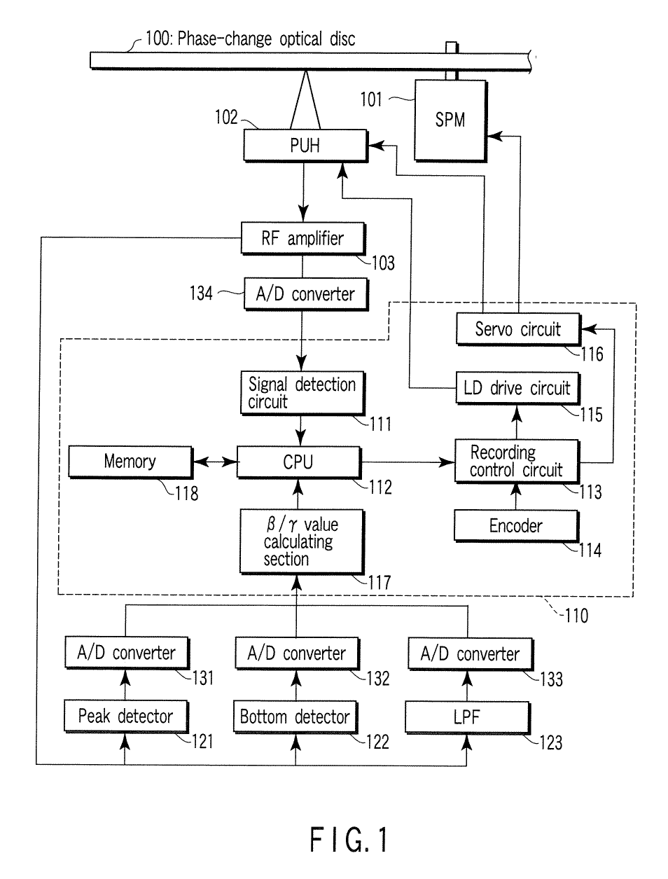

FIG. 1 is a block diagram schematically showing the configuration of an optical disc (recording/read) drive apparatus according to one embodiment of the present invention.

The optical disc drive apparatus includes spindle motor (SPM) 101, pickup head 102, RF amplifier 103, controller 110, peak detector 121, bottom detector 122, low-pass filter (LPF) 123 and AD converter 131 to 134. The spindle motor 101 rotates a phase-change optical disc 100. The pickup head 102 is composed of optical system such as laser diode and objective lens, focusing actuator, tracking actuator, photo detector and lens position sensor.

The controller 110 includes signal detection circuit 111, CPU (central Processing Unit) 112, recording control circuit 113, encoder 114, laser drive circuit (LD drive circuit) 115, servo circuit 116, β/γ value calculating section 117 and memory 118. The memory 118 is stored with various programs and data.

A laser beam emitted from the laser diode of the pickup head (PUH) 101 is radiated to a recording surface of the rotating phase-change optical disc 100, and thereby, data record/read is made. The reflection light reflected from the phase-change optical disc 100 is detected by the photo detector of the pickup head 102, and then, converted into an electric signal.

An output signal of the optical pickup head 102 is amplified via the RF amplifier 103. The signal amplified by the RF amplifier 103 is inputted to controller 110, peak detector 121, bottom detector 122 and low-pass filter 123.

The signal detection circuit 111 of the controller 110 extracts a wobble component from the inputted signal. Based on the extracted wobble component, the signal detection circuit 111 detects a track address of the phase-change optical disc 100 to which a laser beam is radiated. Thereafter, the circuit 111 outputs the detected address to the CPU 112. The CPU 112 recognizes a radial recording position of the phase-change optical disc 100. Then, the CPU 112 outputs a control signal corresponding to the recording position to the recording control circuit 113.

The encoder 114 modulates write information according to a modulation method conformable to the format of the phase-change optical disc 100. Then, the encoder 114 outputs the modulated signal to the recording control circuit 113.

The recording control circuit 113 outputs a drive control signal to laser drive circuit 115 and servo circuit 116 based on the modulation signal from the encoder 114 and the control signal from the CPU 112. The servo circuit 116 controls the rotation of the spindle motor 101 while setting the pickup head 102 to a proper position. Based on the drive control signal, the laser drive circuit 115 conducts the laser diode of the pickup head 102 so that a laser beam is radiated to the phase-change optical disc 100 from the laser diode.

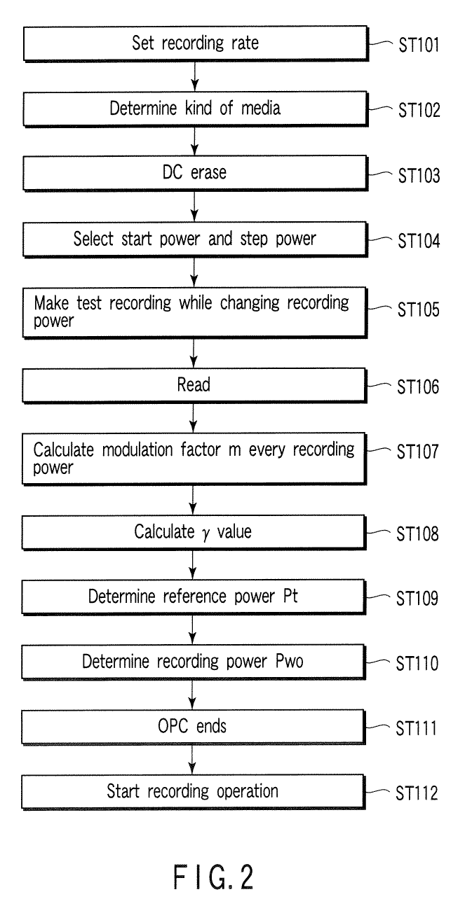

In the optical disc drive apparatus shown in FIG. 1, the OPC for optimizing recording power is carried out before data is recorded to the optical disc 100. The OPC operation will be explained below with reference to the flowchart of FIG. 2.

A recording rate is set to a value specified by a recording command sent from a server (step ST101). The CPU 112 acquires an ID number recorded in a phase-change optical disc 100 recording data, and then, recognizes media from the acquired ID number (step ST102).

The CPU 112 executes DC erase with respect to a write test area (step ST103). According to the DC erase, a laser beam is radiated with predetermined DC erase power to carry out erase. In this case, the DC erase power is larger than normal erase power Pe, and set to a peak power level in actual recording. The DC erase may be carried out with respect to a block in which at least write test is made. The DC erase power PeDC is determined in accordance with a kind of media. Moreover, the DC erase is similar to vapor deposition of phase-change film in actually manufacturing optical discs. Thus, the thickness of phase-change film of the DC erase area is made uniform.

The CPU 112 selects start recording power and step value from a table stored in the memory 118 in accordance with a recording rate (step ST104). The CPU 112 changes the recording power in a range from the selected start recording power to 15 steps at a unit of step value. Thereafter, the CPU 112 records test data to the PCA (Power Calibration Area) of the phase-change optical disc 100 (step ST105). In this case, recording power used when recording the test data is weaker than actual recording power.

The test data is recorded to the PCA of the phase-change optical disc 100, and thereafter, a recorded signal is regenerated (step ST106).

In regeneration, a RF signal corresponding to the reflection light from the phase-change optical disc 100 received by the pickup head 102 is inputted to the RF amplifier 103. The RF amplifier 103 amplifies the inputted RF signal. The amplified RF signal is inputted to peak detector 121, bottom detector 122 and low-pass filter 123.

The peak detector 121 detects a peak level I_{PK} of the amplified RF signal. The bottom detector 122 detects a bottom level I_{BT} of the amplified RF signal. The low-pass filter 123 detects a DC component I_{DC} contained in the amplified RF signal.

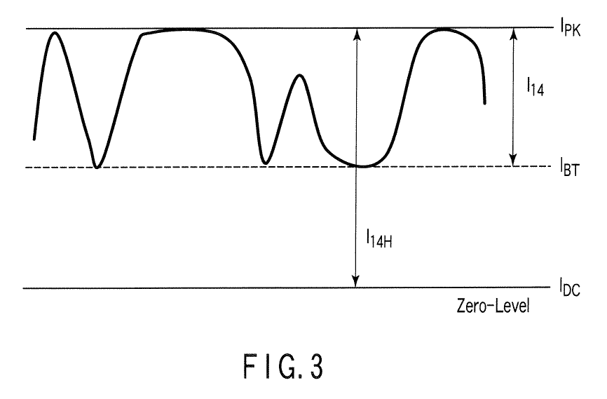

Each signal detected by the foregoing peak detector 121, bottom detector 122 and low-pass filter 123 is converted into a digital signal via AD converters 131 to 133. Then, each signal is inputted to the β/γ value calculating section 117. The β/γ value calculating section 117 calculates a modulation factor m for each of 15-step recording powers from digital-converted peak level I_{PK}, bottom level I_{BT} and DC component I_{DC} thus inputted (step ST107). As shown in FIG. 3, the modulation factor m is calculated from the following equation using the foregoing peak level I_{PK}, bottom level I_{BT} and DC component I_{DC}.
m=I14/I14H=(I_{PK}+I_{BT})/(I_{PK}+I_{DC})

Then, a γ value is calculated from the calculated modulation factor m every recording power (step ST108). The γ value is calculated from the following equation.
γ=(dm/dPw)·(Pw/m)

where, Pw is recording power, the right side “dm/dPw” is a differential value based on the recording power Pw of the modulation factor m.

y value characteristics (recording power—γ value) with respect to recording power are operated from the foregoing recording power and γ value. A reference power Pt is determined from operated recording power—γ value characteristics so that a change γₜ previously designated in the phase-change optical disc 100 is obtained (step ST109). The phase-change optical disc 100 is previously recorded with a target value γₜ of the γ value as ATIP (Absolute Time In Pre-groove) information.

The reference power Pt is multiplied by a coefficient p designated in the phase-change optical disc 100 to determine optimum recording power Pwo (step ST110). The phase-change optical disc 100 is previously recorded with the coefficient ρ for determining the optimum recording power Pwo from the reference power Pt as ATIP information. The foregoing procedures are taken, and thereby, the OPC ends (step ST111).

Thereafter, data is recorded to the phase-change optical disc 100 using the optimum recording power Pwo (step ST112).

Conventionally, DC erase has not been carried out with respect to the PCA. The DC erase is carried out, and thereby, the size of crystal grains of phase-change film of the PCA is made uniform. As a result, the phase-change film normally changes in its phase in accordance with the recording power radiated to the phase-change film. Therefore, the optimum power is accurately determined.

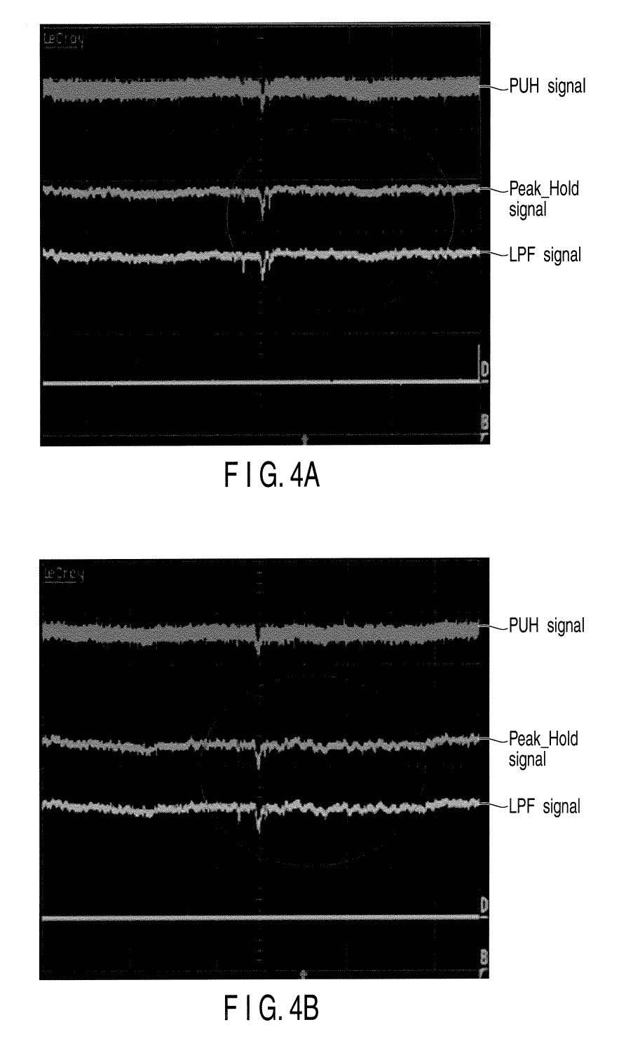

FIG. 4A and FIG. 4B show of RF signal waveforms of the cases where DC erase is carried out and it is not carried out before recording is made with respect to PCA while changing recording power. FIG. 4A shows a RF signal waveform of the case where DC erase is carried out with respect to the PCA. On the other hand, FIG. 4B shows a RF signal waveform of the case where DC erase is not carried out with respect to the PCA. In FIG. 4A and FIG. 4B, a PUH signal is a signal outputted from the pickup head, a Peak_Hold signal is an output signal from the peak detector 121, and a LPF signal is an output signal from the low-pass filter 123. As described above, the peak level I_{PK} of the Peak_Hold signal and the DC component I_{DC} of the LPF signal are used to calculate a γ value. Thus, each noise (non-uniform component) of the foregoing Peak_Hold and LPF signals give an influence to the OPC for calculating the actual recoding power.

It can be seen that the waveform shown in FIG. 4A carrying out the DC erase has noise less than the waveform shown in FIG. 4B carrying out no DC erase. Therefore, test recording is made after the DC erase is carried out with respect to the PCA, and thereby, a noise of generative (read) signal is reduced. This serves to optimize the calculated recording power.

For example, in order to determine optimum recording power of a write-once read optical disc such as CD-R or DVD-R, a recording test is made at an actual recording power; namely, a so-called β test is made. On the other hand, in order to determine optimum recording power of the rewritable phase-change optical disc described in the embodiment, a recording test is made at recording power weaker than the actual recording power; namely, a so-called γ test is made. In this case, the optimum recording power of rewritable phase-change optical disc may be determined using the β test like the case of write-once read optical disc.

The following is an explanation about the case of determining the optimum recording power using the β test. The recording test is made with respect to PCA while changing recording power. An area making the recording test is read to obtain a regenerative (read) signal. Then, peak level I_{PK} and bottom level I_{BT} are detected from the regenerative signal every recording power. A β value is calculated from the foregoing peak level I_{PK} and bottom level IBT every recording power. The β value is calculated from peak level I_{PK} and bottom level I_{BT} using the following equation.
β=(I_{PK}+I_{BT})/(I_{PK}−I_{BT})

β value characteristics with respect to recording power are obtained from the foregoing recording power and β value. Recording power capable of obtaining a predetermined target β value is determined from the characteristics. The determined recording power is set as optimum recording power. Incidentally, the β value is calculated using the β/γ value calculating section 117.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of determining a recording power, comprising:
carrying out DC erase to a power calibration area of a phase-change optical disc;
recording data to the power calibration area after carrying out the DC erase while changing recording power;
reading the recorded data to obtain a read signal; and
determining an optimum recording power based on the read signal.

2. The method of determining a recording power according to claim 1, wherein determining the optimum recording power comprises,
calculating a modulation factor every recording power based on the read signal,
calculating a γ value every the recoding power using the modulation factor calculated for each recording power,
calculating γ value characteristics with respect to recording power based on the recording power and the γ value used every the recoding power,
determining a reference recording power capable of obtaining a predetermined target γ value from the obtained characteristics, and
multiplying the reference power by a coefficient ρ.

3. The method of determining a recording power according to claim 2, wherein the calculating of a modulation factor m comprises,
detecting a peak level I_{PK} of the read signal,
detecting a bottom level I_{BT} of the read signal,
detecting a DC component I_{DC} contained in the read signal, wherein
calculating a following expression;
m=(I_{PK}+I_{BT})/(I_{PK}+I_{DC})

4. The method of determining a recording power according to claim 2, wherein the γ value is calculated a following expression;
γ=(dm/dPw)·(Pw/m)
where Pw is recording power, “dm/dPw” is a differential value based on the recording power Pw of the modulation factor m.

5. An optical disc drive apparatus making test recording with respect to a power calibration area of a phase-change optical disc while changing recording power, comprising:
a control section carrying out DC erase to the power calibration area before the test recording is made.

6. The optical disc drive apparatus according to claim 5, wherein the control section includes a γ value calculating section calculating a γ value every recording power based on the read signal, and a recording power determination section determining an optimum recording power based on the γ value.

7. The optical disc drive apparatus according to claim 6, further comprises, a peak detector configure detect a peak level I_{PK} of the read signal,
a bottom detector configure to detect a bottom level I_{BT} of the read signal,
a DC component detector configure to detect a DC component I_{DC} contained in the read signal, wherein the γ value calculating section calculating a modulation factor m every recording power a following expression;
m=(I_{PK}+I_{BT})/(I_{PK}+I_{DC}).

8. The optical disc drive apparatus according to claim 7, the γ value calculating section calculating a following expression;
γ=(dm/dPw)·(Pw/m)
where Pw is recording power, “dm/dPw” is a differential value based on the recording power Pw of the modulation factor m.
